(19) United States
(12) Patent Application Publication
(10) Pub. No.: US 2017/0125772 A1
(43) Pub. Date: May 4, 2017

(54) Push-On Clip

(71) Applicants: Bosch Battery Systems GmbH, Stuttgart (DE); Robert Bosch GmbH, Stuttgart (DE)

(72) Inventors: Kuen Cheuk Leung, Rochester Hills, MI (US); George Alfred Campbell, Rochester Hills, MI (US)

(21) Appl. No.: 14/925,042

(22) Filed: Oct. 28, 2015

(51) Int. Cl. H01M 2/20

(52) U.S. Cl. CPC H01M 2/206; H01M 2220/20

(57) ABSTRACT

A battery system includes a first cell that is electrically connected to a second cell via a push-on clip. The clip is an electrically conductive plate that includes a first cutout that is configured to receive and snap onto a first terminal of the first cell, and a second cutout that is configured to receive and snap onto a second terminal of the second cell. The first and second cutouts are irregularly shaped and formed in the peripheral edge of the clip. The first and second terminals each have a widened distal end, and an interference fit is formed between the clip cutouts and the corresponding widened distal end, whereby a secure electrical connection between the terminals and the clip is provided.

### BACKGROUND

1. Field of the Invention

The present invention relates to terminal connectors for forming electrical connections between terminals of two or more electrochemical cells, and, more particularly, to an electrically conductive clip for forming a snap-on connection between the electrical terminals of adjacent cells having post-type terminals.

2. Description of the Related Art

Battery packs provide power for various technologies ranging from portable electronics to renewable power systems and environmentally friendly vehicles. For example, hybrid electric vehicles (HEV) use a battery pack and an electric motor in conjunction with a combustion engine to increase fuel efficiency. Battery packs are formed of a plurality of battery modules, where each battery module includes several electrochemical cells. The cells are arranged in stacks and are electrically connected in series or in parallel. Likewise, the battery modules within a battery pack are electrically connected in series or in parallel. In some conventional battery packs, the cell-to-cell electrical connections may be formed by welding an electrical conductor to the respective cell terminals, which be problematic since welding introduces elevated temperatures to the cells. Such elevated temperatures can damage the cell, and for some types of cells such as Lithium-ion cells, the elevated temperature can lead to an explosion. Moreover, it is difficult to replace an individual cell once it has been connected to the battery system by welding, whereby servicing of the corresponding battery pack becomes expensive. In other conventional battery packs, the cell-to-cell electrical connections may be formed using mechanical methods such as attaching electrical conductors to the cell terminals. For example, the cell-to-cell electrical connections may be formed via a fastener such as a nut and threaded stud. Use of this type of mechanical fastener is labor-intensive and can be prone to difficulties such as those related to over or under tightening of the fastener.

### SUMMARY

In some aspects, a clip is used for electrically connecting a first terminal of a first cell to a second terminal of a second cell. The clip includes an electrically conductive plate having a cell-facing surface, an outward-facing surface that is opposed to the cell-facing surface, and a peripheral edge that extends between the cell-facing surface and the outward-facing surface. A first cutout is formed in the peripheral edge so as to extend through a thickness of the clip. The thickness of the clip corresponds to a distance between the cell-facing surface and the outward-facing surface. In addition, the first cutout is shaped and dimensioned to receive and retain one of the first terminal and the second terminal.

The clip may include one or more of the following features: The first cutout includes a tapered portion that adjoins a portion of the peripheral edge, and a widened portion that is spaced apart from the peripheral edge, and intersects the tapered portion. The widened portion has a shape that corresponds to the shape of the one of the first terminal and the second terminal, and a dimension that is configured to receive the one of the first terminal and the second terminal with a clearance fit. The tapered portion has a wide end at a location corresponding to the portion of the peripheral edge and a narrow end at the intersection with the widened portion. A dimension of the wide end in a direction parallel to the portion of the peripheral edge is greater than a dimension of the narrow end in a direction parallel to the portion of the peripheral edge, and a spacing between facing inner surfaces of the cutout at the narrow end has a dimension that is smaller than a dimension of the one of the first terminal and the second terminal. The first cutout comprises a slit portion that intersects with the widened portion such that the widened portion is disposed between the tapered portion and the slit portion, and the slit portion is an opening through the thickness of the clip that is elongated in a direction perpendicular to the portion of the peripheral edge. The clip includes a second cutout formed in the peripheral edge, and the second cutout is shaped and dimensioned to receive and retain the other of the first cell terminal and the second cell terminal.

The clip may also include one or more of the following additional features: The clip includes a second cutout formed in the peripheral edge, and the second cutout has the same shape and size as the first cutout. The clip includes a second cutout formed in the peripheral edge, and the first cut out and the second cutout open along the peripheral edge in a common direction. The clip includes a U-shaped fold that is disposed between the first cutout and the second cutout. The U-shaped fold comprises a protrusion that protrudes outward from the outward-facing surface of the clip, and a recess that is formed in the cell-facing surface at a location corresponding to the protrusion. The peripheral edge comprises a first edge portion that is parallel to and spaced apart from a second edge portion, wherein the first cutout and the second cutout are formed in the first side edge, and the U-shaped fold extends between the first side edge and the second side edge.

In some aspects, a battery system includes a first cell having an electrically conductive first terminal, a second cell having an electrically conductive second terminal, and a clip that provides an electrical connection between the first terminal and the second terminal. The clip includes an electrically conductive plate having a cell-facing surface, an outward-facing surface that is opposed to the cell-facing surface, and a peripheral edge that extends between the cell-facing surface and the outward-facing surface. A first cutout is formed in the peripheral edge so as to extend through a thickness of the clip. The thickness of the clip corresponds to a distance between the cell-facing surface and the outward-facing surface, and the first cutout receives and retains one of the first terminal and the second terminal.

The battery system may include one or more of the following features: The one of the first terminal and the second terminal includes a proximal end that is connected to the one of the respective first cell and second cell, the proximal end having a first cross-sectional dimension, a distal end that is opposed to the proximal end and spaced apart from the one of the first cell and second cell, the distal end having a second cross sectional dimension, and a mid-portion disposed between the proximal end and the distal end, the mid-portion having a third cross-sectional dimension. The third cross sectional dimension is smaller than the first cross-sectional dimension and the second cross-sectional dimension, and wherein the first cutout is shaped and dimensioned to receive and retain the mid-portion of the one of the first terminal and the second terminal. The distal end is rounded in shape. Each of the first terminal and the second terminal includes a proximal end that is disposed on a surface of a respective one of the first cell the second cell, and each of the first cell terminal and the second cell terminal terminates in a distal end that is opposed to the proximal end and spaced apart from the surface. In addition, each of the first cell terminal and the second cell terminal includes a mid-portion disposed between the proximal end and the distal end. The mid-portion has a cross-sectional dimension that is smaller than the cross-sectional dimensions of the proximal end and the distal end, and the clip has a thickness that is equal to or greater than a distance between the proximal end and the distal end such that when the first cutout receives and retains the mid-portion of the one of the first terminal and the second terminal, an interference fit exists between the clip and surfaces of the proximal end and the distal end, where the clip thickness corresponds to a distance between the cell-facing surface of the clip and the outward-facing surface of the clip. The first cutout is formed in a first portion of the peripheral edge, and a second cutout is formed in the first portion of the peripheral edge so as to extend through a thickness of the clip. The second cutout is spaced apart from the first cutout along the first portion, and the second cutout receives and retains the other of the first terminal and the second terminal. The first cutout and the second cutout each include a tapered portion that adjoins the first portion of the peripheral edge, a widened portion that is spaced apart from the first portion peripheral edge, and intersects the tapered portion. The tapered portion has a wide end at a location corresponding to the first portion of the peripheral edge and a narrow end at the intersection with the widened portion. A dimension of the wide end in a direction parallel to the first portion of the peripheral edge is greater than a dimension of the narrow end in a direction parallel to the first portion of the peripheral edge, and a spacing between facing inner surfaces of the cutout at the narrow end has a dimension that is smaller than a dimension of the one of the first terminal and the second terminal.

In some aspects, a method of electrically connecting a first cell having a first terminal to a second cell having a second terminal includes providing clip that includes an electrically conductive plate. The clip includes a cell-facing surface, an outward-facing surface that is opposed to the cell-facing surface, and a peripheral edge that extends between the cell-facing surface and the outward-facing surface. The clip includes a first cutout formed in a first portion of the peripheral edge so as to extend through a thickness of the clip where the thickness of the clip corresponds to a distance between the cell-facing surface and the outward-facing surface, and the first cutout is shaped and dimensioned to receive and retain one of the first terminal and the second terminal. In addition, the clip includes a second cutout formed in the first portion of the peripheral edge so as to extend through a thickness of the clip, where the second cutout is spaced apart from the first cutout along the first portion, and the second cutout is shaped and dimensioned to receive and retain the other of the first terminal and the second terminal. The method includes electrically connecting the clip to the first terminal by inserting the one of the first terminal and the second terminal into the first cutout to an extent that it is received within the first cutout, and electrically connecting the clip to the second terminal by inserting the other of the first cell terminal and the second cell terminal into the second cutout to an extent that it is received within the second cutout.

The method may include the following features: Each of the first terminal and the second terminal protrude from a surface of a respective one of the first cell the second cell, and each of the first terminal and the second terminal include an outer surface that defines a recess, the recess having facing surfaces that are separated by a gap. The clip has a thickness that is equal to or greater than a distance between the facing surfaces of the recess such that an interference fit exists between the clip and the facing surfaces of the recess, where the clip thickness corresponds to a distance between a cell-facing surface of the clip and an outward-facing surface of the clip, and the outward-facing surface of the clip is opposed to the cell-facing surface of the clip.

In some aspects, an electrically conductive clip is provided that can be pushed onto an electrochemical cell terminal using a snap fit. The clip is an electrically conductive plate that includes a pair of side-by-side cutouts that are each shaped and dimensioned to receive and retain a cell terminal therein in via an interference fit electrical connection. The clip is configured to improve the electrical throughput of the battery module assembly, while reducing the number of parts required to form electrical connections between individual cells of the battery module assembly. Advantageously, the clip can be easily and quickly pushed onto the terminals and retained on the terminals via a snap type connection, whereby the labor and capital investment of welding or using nut and stud fasteners can be avoided.

### BRIEF DESCRIPTION OF THE DRAWINGS

FIG. 1 illustrates the main elements of a battery pack, including an electrochemical cell, a battery module in which individual cells are electrically connected via a clip, a subunit and the battery pack.

FIG. 2 is a cross sectional view of the clip of FIG. 2 assembled with a terminal of an electrochemical cell.

FIG. 3 is a perspective view of an electrically conductive clip.

FIG. 4 is a perspective exploded view of a pair of electrochemical cells that are electrically connected via the clip of FIG. 2.

FIG. 5 is a perspective assembled view of the pair of electrochemical cells and the clip of FIG. 2.

### DETAILED DESCRIPTION

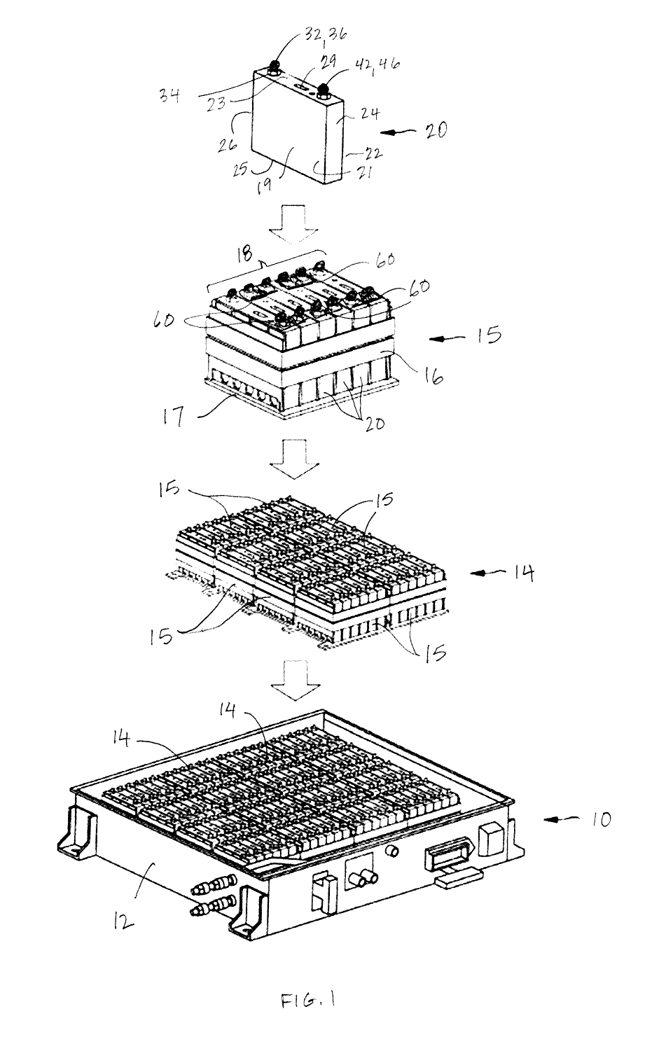

Referring to FIG. 1, a battery system 10 used to provide electrical power includes prismatic electrochemical cells 20 that are electrically interconnected and stored in an organized manner within a battery pack housing 12. The term “prismatic” as used herein refers to having a rectangular shape. The cells 20 are arranged in a side-by-side configuration to form a stack 18, and several cells 20 in the stacked arrangement are bundled together to form a battery module 15. Within the battery module 15, the stacked group of cells 20 may be commonly supported on a support plate 17 and bound together under compression via a band 16. Although the illustrated embodiment of the battery module 15 includes six cells 20, battery modules 15 may include a greater or fewer number of cells 20. Several battery modules 15 are collected into subunits 14, and several subunits 14 are arranged within the battery pack housing 12. The cells 20 are connected electrically in series or in parallel using electrically conductive clips 60 that can be easily pushed onto a terminal of a cell 20 using a snap-on connection. A clip 60 is described in detail below.

The cells 20 are prismatic lithium-ion cells. Each cell 20 includes a cell housing 19. An electrode assembly (not shown) is sealed within the cell housing 19 along with an electrolyte to form a power generation and storage unit. The electrode assembly may be, but is not limited to, a “jelly roll” electrode assembly that includes a positive electrode, a negative electrode and an intermediate separator provided in a stacked and rolled arrangement.

Each cell housing 19 includes opposed broad sides 21, 22 and four relatively narrow end surfaces 23, 24, 25, 26 that extend between the broad sides 21, 22. In the illustrated embodiment, a first end surface 23 and a third end surface 25 are on opposed sides of the cell 20 and are longer than a second end surface 24 and a fourth end surface 26. The second and fourth end surfaces 24, 26 extend perpendicularly to the first and third end surfaces 23, 25. Each cell 20 includes a vent 29 that opens through the first end surface 23.

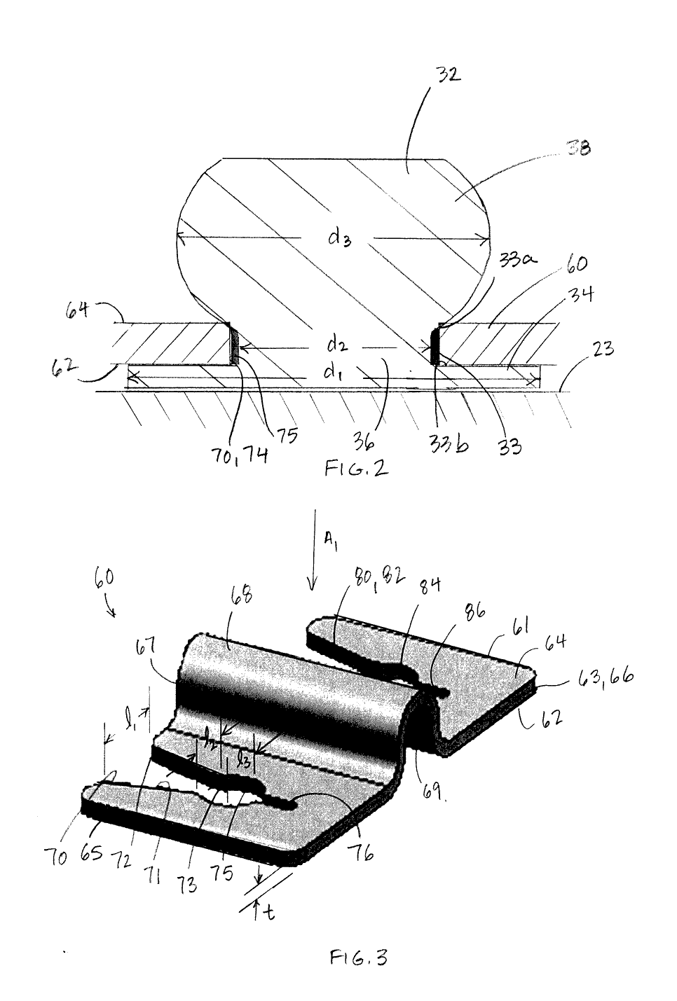

Referring to FIG. 2, each cell 20 also includes a positive terminal 32 that is electrically connected to the positive electrode, and a negative terminal 42 that is electrically connected to the negative electrode. The positive and negative terminals 32, 42 protrude from the first end surface 23. The positive and negative terminals 32, 42 have the same shape and dimensions, and thus only the positive terminal 32 will be described here. The positive terminal 32 includes a plate-shaped proximal end 34 that overlies, is supported by, and electrically insulated from, the cell first end surface 23. The positive terminal 32 includes a rounded distal end 38 that is opposed to the proximal end 34 and spaced apart from the cell first end surface 23. In the illustrated embodiment, the distal end 38 has the shape of a truncated sphere. In addition, the positive terminal 32 includes a mid-portion 36 disposed between the proximal end 34 and the distal end 38. The mid-portion 36 is generally cylindrical, and has a smaller cross-sectional dimension than both the proximal end 34 and the distal end 38. In particular, the mid-portion 34 has a cross-sectional dimension d2 that is less than the corresponding dimension d1 of the proximal end 34 and the maximum dimension d3 of the distal end 38. As a result, the positive terminal 32 has an irregular shape in which the distal end 38 is enlarged in size relative to the mid-portion 36, and an annular recess 33 is formed between the proximal and distal ends 34, 38.

Referring to FIG. 3, a clip 60 is an electrically conductive plate that may be used to electrically connect a first terminal, for example the positive terminal 32a of a first cell 20a to a second terminal, for example the negative terminal 42b of a second cell 20b. The clip 60 includes a cell-facing surface 62, and an outward-facing surface 64 that is opposed to the cell-facing surface 62. The clip 60 also includes a peripheral edge 66 that extends between the cell-facing surface 62 and the outward-facing surface 64. The clip thickness t, which corresponds to the distance between the cell-facing surface 62 and the outward-facing surface 64, is very small relative to a length and width of the cell-facing surface 62 and the outward-facing surface 64.

The clip 60 has a generally rectangular profile when the clip 60 is viewed in the direction of the arrow A1 shown in FIG. 3, e.g., in top plan view. Thus the peripheral edge 66 defines four edge portions 61, 63, 65, 67 of the clip 60, where the first and third edge portions 61, 65 are parallel, and the second and fourth edge portions 63, 67 are transverse to the first and third edge portions 61, 65.

In addition, the clip 60 includes a first cutout 70 and a second cut out 80 formed in the peripheral edge 66. As used herein, the term “cutout” refers to a space or hole left after cutting something out from something else. In clip 60, material has been removed from the clip 60 along the peripheral edge 66 so that a convexity is formed in the peripheral edge 66. The first cutout 70 is spaced apart from the second cutout 80 along the fourth edge portion 67 of the peripheral edge 66.

The clip 60 is generally planar except for a U-shaped protrusion, or fold, 68 that is disposed between the first cutout 70 and the second cutout 80. The fold 68 extends across a width of the clip 60, e.g., between the second edge portion 63 and the fourth edge portion 67, and protrudes outward from the outward-facing surface 64. The clip 60 is of uniform thickness, whereby a corresponding recess 69 is formed in the cell-facing surface 62 at a location corresponding to the fold 68. The fold 68 provides flexibility to the clip 60, allowing it to expand or compress within the plane and thus accommodate variations in spacing between terminals. In also allows for slight movement between interconnected cells 20 without unduly stressing the corresponding interconnected terminals 32a, 42b.

The first cutout 70 and the second cutout 80 are identical in size and shape, and so only the first cutout 70 will be described in detail. The first cutout 70 is shaped and dimensioned to receive and retain one of the positive cell terminal 32 and the negative cell terminal 42 in a snap-fit manner. The first cutout 70 extends through the thickness t of the plate and forms a concavity in the peripheral edge 66 that is irregularly shaped when the clip 60 is viewed in top plan view. In particular, the first cutout 70 includes a tapered portion 71 that adjoins the fourth edge portion 67 of the peripheral edge 66, a slit portion 76 that is spaced apart from the peripheral edge 66, and a widened portion 75 that is disposed between, and joins, the tapered portion 71 to the slit portion 76.

The tapered portion 71 has a wide end 72 at a location corresponding to the fourth edge portion 67, and a narrow end 73 at an intersection with the widened portion 75. That is, a dimension l1 of the wide end 72 in a direction parallel to the fourth edge portion 67 (e.g., the spacing between facing inner surfaces of the tapered portion 71 at the wide end 72) is greater than a dimension l2 of the narrow end 73 in a direction parallel to the fourth edge portion 67 (e.g., the spacing between facing inner surfaces of the tapered portion 71 at the narrow end 73). The spacing l1 between facing inner surfaces of the tapered portion 72 at the wide end 72 has a dimension that is much larger than that of the terminal mid-portion 36 to facilitate easy insertion of the terminal 32 into the cutout 70. For example, the spacing l1 between facing inner surfaces at the wide end 72 may be in a range of 2 to 5 times the diameter of the terminal proximal end 34. In addition, the spacing l2 between facing inner surfaces of the tapered portion 71 at the narrow end 73 has a dimension that is smaller than the dimension d2 of the mid-portion 36 of the terminal 32, whereby passage of the terminal mid-portion 36 from the tapered portion 71 into widened portion 75 occurs via deflection of the facing inner surfaces of the tapered portion 71. This deflection is facilitated by the presence of the stress-relieving slit portion 76, which is a narrow opening in the clip 60 that is elongated in a direction perpendicular to the fourth edge portion 67.

The widened portion 75, which is intermediate to, and connects, the tapered portion 71 to the slit portion 76, has a shape when viewed in plan view that corresponds to the cross-sectional shape of the terminal mid-portion 36. For example, in the illustrated embodiment, the widened portion 75 has a circular shape when viewed in plan view to correspond to the circular cross-sectional shape of the terminal mid-portion 36. The widened portion 75 has a maximum dimension l3 that is sized to receive the terminal mid-portion 36 with a clearance fit. As used herein, the term “clearance fit” refers to a fit type where clearance exists between assembled parts under all tolerance conditions. However, the thickness t of the clip 60 and/or the spacing of the terminal distal end 38 from the terminal proximal end 34 is set such that an interference fit exists between the clip 60 and the proximal and distal ends 34, 38 of the terminal 32, 42. In particular, an interference fit exists between the cell-facing and the outward-facing surfaces 62, 64 of the clip 60 and the facing surfaces 33a, 33b of the recess 33. As used herein, the term “interference fit” refers to a fit type where interference exists between assembled parts under all tolerance conditions. As a result of the shape of the cutout 70 and due to the interference fit between the clip 60 and the terminal 32, 42, the cutout 70 serve to receive and retain the terminal mid-portion 36 therein.

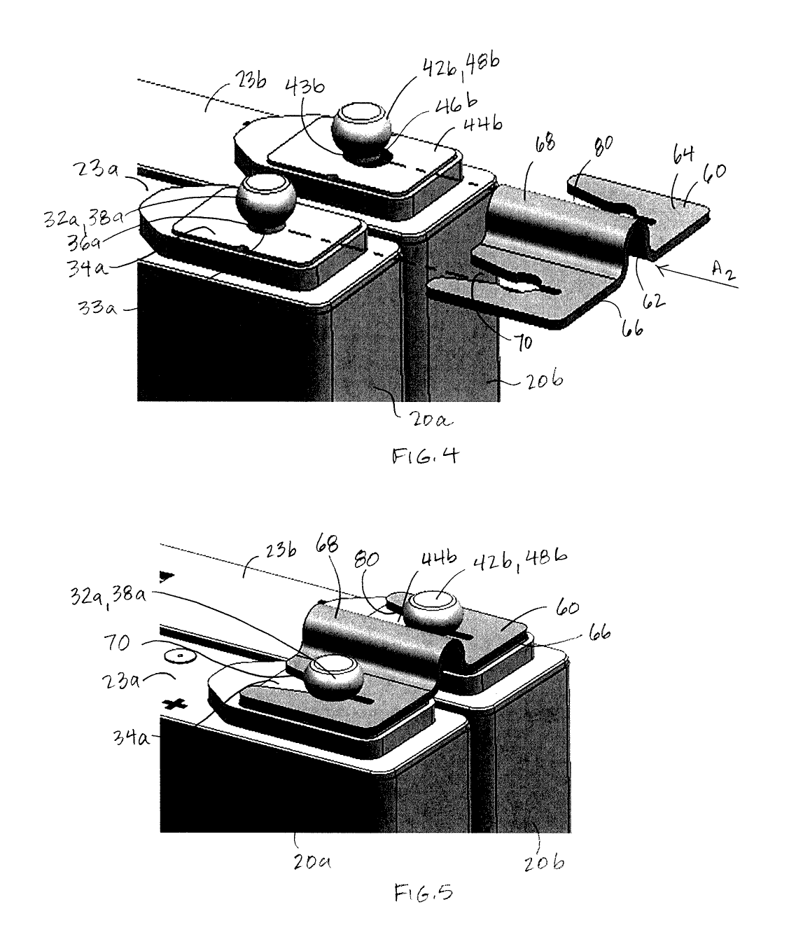

Referring to FIGS. 4 and 5, to electrically connect the positive terminal 32a of the first cell 20a to the negative terminal 42b of a second cell 20b, the clip 60 is pushed onto the terminals 32a, 42b from the side (e.g., in the direction corresponding to the arrow A2 shown in FIG. 4) so that the terminal mid-portion 36a of the positive terminal 32a of the first cell 20a is disposed in the first cutout 70, and the terminal mid-portion 46b of the negative terminal 42b of the second cell 20b is disposed in the second cutout 80. Within each cut out 70, 80, the terminal mid-portions 36a, 46b will pass through the tapered portions 71 of the first and second cutouts 70, 80 from the wide end 72 to the narrow end 73. Since the clip 60 is dimensioned so that the the spacing l2 between facing inner surfaces of the tapered portion 71 at the narrow end 73 has a dimension that is smaller than the dimension d2 of the terminal mid-portions 36a, 46b of the cell terminal 32a, 42b, passage of the terminal mid-portions 36a, 46b from the tapered portion 71 into widened portion 75 occurs via deflection of the facing inner surfaces of the tapered portion 71. In particular, the clip 60 deforms to permit passage of the terminal distal end into the widened portion 75, and then elastically returns to the undeformed shape (e.g., snaps back to its original shape). Thus, the terminal proximal end 34a, 44b is retained within the widened portion 75 via a snap-on engagement by the tapered portion narrow end 73. Since the tapered portion narrow end 73 is dimensioned to be smaller than terminal mid-portions 36a, 46b, this ensures the terminal 32a, 42b will not easily slip out of the respective cutout 70, 80 once the clip 60 is snapped on. In addition, due to the interference fit between the recess 33a, 43b of each terminal 32a, 42b and the clip surfaces 62, 64, a downward force is applied to the clip 60 and pushes the clip 60 tightly against the terminal proximal end 34a, 44b and prevents movement between the clip 60 and the respective cell 20a, 20b. The rounded shape of the terminal distal ends 38a, 48b provides easy access for pushing of the clip 60, and also accommodates slight movement, or size variance, in between cells 20a, 20b.

Due to the shape of the clip 60, a reliable electrical connection is easily and quickly formed between the positive terminal 32a of the first cell 20a and the negative terminal 42b of the second cell 20b via the clip 60. The connection is made without additional components and without requiring the use of specialize equipment.

Although the cell 20 described in the illustrated embodiment is a lithium-ion electrochemical cell, the cells 20 that are connected using the clip are not limited to a lithium-ion electrochemical cell. For example, the cell 20 may be a nickel metal hydride, nickel cadmium cell, aluminium-ion cell or other type of cell. Moreover, although the cell 20 is described as having a prismatic shape, the cell 20 may be formed in a different shape, such as cylindrical or pouch shape.

Although the clip 60 is described as having a generally rectangular profile when seen in top plan view, the clip 60 is not limited to a rectangular shape. For example, in some embodiments, the clip 60 may be elliptical in shape when seen in top plan view.

In the illustrated embodiment, the first cutout 70 is spaced apart from the second cutout 80 along the fourth edge portion 67 of the peripheral edge 66, whereby the first cutout 70 and the second cutout 80 open in the same direction. However, the clip 60 is not limited to this configuration. For example, in some embodiments, the first cutout 70 is spaced apart from the second cutout 80, but opens in a direction opposed to that of the second cutout 80. For example, in an alternative clip 60′ (not shown) the first cutout 70 opens along the fourth edge portion 67 on one side of the fold 68, and the second cutout 80 opens along the second edge portion 63 on the opposed side of the fold 68. In this example, the shape of the first and second cutouts 70, 80 may be modified to accommodate a rotational motion of the clip 60′ during assembly with the respective cell terminals.

Although the terminal distal end 36 is described as having a rounded or spherical shape, the terminal distal end 36 is not limited to a rounded shape. For example, in some embodiments, the terminal distal end 36 may be polygonal and includes a tapered surface of flat surface that is configured to provide an interference fit between the clip 60 and the proximal and distal ends terminal 32, 42.

Although the terminals 32, 42 are disclosed as being disposed on the first end surface 23 of the cell 20, the terminals are not limited to this location. For example, depending on the requirements of the specific application, the terminals 32, 42 can be disposed on any of the end surfaces 23, 24, 25, 26 or on the broad sides 21, 22.

Although the positive terminal 32 is disclosed as being identical to the negative terminal 42, it is contemplated that terminals 32, 42 may differ in shape and/or dimensions as required by the specific application. Moreover, although the terminal proximal end 34 is described and/or illustrated as having the form of a rectangular plate and the distal end 38 is described as being rounded, the terminal can be of different shape and dimensions as long as the proximal end is flat and the distal end is enlarged relative to the mid-portion 36.

Selective illustrative embodiments of the elastic member are described above in some detail. It should be understood that only structures considered necessary for clarifying the elastic member have been described herein. Other conventional structures, and those of ancillary and auxiliary components of the battery system, are assumed to be known and understood by those skilled in the art. Moreover, while working examples of the elastic member been described above, the elastic member is not limited to the working examples described above, but various design alterations may be carried out without departing from the device as set forth in the claims.

What is claimed, is:

1. A clip for electrically connecting a first terminal of a first cell to a second terminal of a second cell, the clip comprising an electrically conductive plate including
a cell-facing surface, an outward-facing surface that is opposed to the cell-facing surface, and a peripheral edge that extends between the cell-facing surface and the outward-facing surface, and
a first cutout formed in the peripheral edge so as to extend through a thickness of the clip, wherein
the thickness of the clip corresponds to a distance between the cell-facing surface and the outward-facing surface, and
the first cutout is shaped and dimensioned to receive and retain one of the first terminal and the second terminal.

2. The clip of claim 1, wherein the first cutout includes
a tapered portion that adjoins a portion of the peripheral edge, and
a widened portion that is spaced apart from the peripheral edge, and intersects the tapered portion.

3. The clip of claim 2, wherein the widened portion has a shape that corresponds to the shape of the one of the first terminal and the second terminal, and a dimension that is configured to receive the one of the first terminal and the second terminal with a clearance fit.

4. The clip of claim 2, wherein
the tapered portion has a wide end at a location corresponding to the portion of the peripheral edge and a narrow end at the intersection with the widened portion,
a dimension of the wide end in a direction parallel to the portion of the peripheral edge is greater than a dimension of the narrow end in a direction parallel to the portion of the peripheral edge, and
a spacing between facing inner surfaces of the cutout at the narrow end has a dimension that is smaller than a dimension of the one of the first terminal and the second terminal.

5. The clip of claim 2, wherein the first cutout comprises a slit portion that intersects with the widened portion such that the widened portion is disposed between the tapered portion and the slit portion, and the slit portion is an opening through the thickness of the clip that is elongated in a direction perpendicular to the portion of the peripheral edge.

6. The clip of claim 1, wherein the clip includes a second cutout formed in the peripheral edge, and the second cutout is shaped and dimensioned to receive and retain the other of the first terminal and the second terminal.

7. The clip of claim 1, wherein the clip includes a second cutout formed in the peripheral edge, and the second cutout has the same shape and size as the first cutout.

8. The clip of claim 1, wherein
the clip includes a second cutout formed in the peripheral edge, and
the first cut out and the second cutout open along the peripheral edge in a common direction.

9. The clip of claim 8, wherein the clip includes a U-shaped fold that is disposed between the first cutout and the second cutout.

10. The clip of claim 9, wherein the U-shaped fold comprises
a protrusion that protrudes outward from the outward-facing surface of the clip, and
a recess that is formed in the cell-facing surface at a location corresponding to the protrusion.

11. The clip of claim 9, wherein the peripheral edge comprises a first edge portion that is parallel to and spaced apart from a second edge portion, wherein the first cutout and the second cutout are formed in the first side edge, and the U-shaped fold extends between the first side edge and the second side edge.

12. A battery system comprising
a first cell including an electrically conductive first terminal,
a second cell including an electrically conductive second terminal, and
a clip that provides an electrical connection between the first terminal and the second terminal, the clip including an electrically conductive plate having
a cell-facing surface, an outward-facing surface that is opposed to the cell-facing surface, and a peripheral edge that extends between the cell-facing surface and the outward-facing surface,
a first cutout formed in the peripheral edge so as to extend through a thickness of the clip, and
wherein
the thickness of the clip corresponds to a distance between the cell-facing surface and the outward-facing surface, and
the first cutout receives and retains one of the first terminal and the second terminal.

13. The battery system of claim 12, wherein the one of the first terminal and the second terminal includes
a proximal end that is connected to the one of the respective first cell and second cell, the proximal end having a first cross-sectional dimension,
a distal end that is opposed to the proximal end and spaced apart from the one of the first cell and second cell, the distal end having a second cross sectional dimension, and
a mid-portion disposed between the proximal end and the distal end, the mid-portion having a third cross-sectional dimension, where the third cross sectional dimension is smaller than the first cross-sectional dimension and the second cross-sectional dimension,
wherein the first cutout is shaped and dimensioned to receive and retain the mid-portion of the one of the first terminal and the second terminal.

14. The battery system of claim 13, wherein the distal end is rounded in shape.

15. The battery system of claim 12, wherein
each of the first terminal and the second terminal includes a proximal end that is disposed on a surface of a respective one of the first cell the second cell,
each of the first cell terminal and the second cell terminal terminates in a distal end that is opposed to the proximal end and spaced apart from the surface,
each of the first cell terminal and the second cell terminal includes a mid-portion disposed between the proximal end and the distal end, the mid-portion having a cross-sectional dimension that is smaller than the cross-sectional dimensions of the proximal end and the distal end, and
the clip has a thickness that is equal to or greater than a distance between the proximal end and the distal end such that when the first cutout receives and retains the mid-portion of the one of the first terminal and the second terminal, an interference fit exists between the clip and surfaces of the proximal end and the distal end, where the clip thickness corresponds to a distance between the cell-facing surface of the clip and the outward-facing surface of the clip.

16. The battery system of claim 12, wherein
the first cutout is formed in a first portion of the peripheral edge,
a second cutout is formed in the first portion of the peripheral edge so as to extend through a thickness of the clip, and the second cutout is spaced apart from the first cutout along the first portion,
the second cutout receives and retains the other of the first terminal and the second terminal.

17. The battery system of claim 16, wherein the first cutout and the second cutout each include
a tapered portion that adjoins the first portion of the peripheral edge, and
a widened portion that is spaced apart from the first portion peripheral edge, and intersects the tapered portion.

18. The battery system of claim 17, wherein
the tapered portion has a wide end at a location corresponding to the first portion of the peripheral edge and a narrow end at the intersection with the widened portion,
a dimension of the wide end in a direction parallel to the first portion of the peripheral edge is greater than a dimension of the narrow end in a direction parallel to the first portion of the peripheral edge, and
a spacing between facing inner surfaces of the cutout at the narrow end has a dimension that is smaller than a dimension of the one of the first terminal and the second terminal.

19. A method of electrically connecting a first cell having a first terminal to a second cell having a second terminal, the method comprising
providing clip that includes an electrically conductive plate having
a cell-facing surface, an outward-facing surface that is opposed to the cell-facing surface, and a peripheral edge that extends between the cell-facing surface and the outward-facing surface,
a first cutout formed in a first portion of the peripheral edge so as to extend through a thickness of the clip where the thickness of the clip corresponds to a distance between the cell-facing surface and the outward-facing surface, and the first cutout is shaped and dimensioned to receive and retain one of the first terminal and the second terminal, and
a second cutout formed in the first portion of the peripheral edge so as to extend through a thickness of the clip, where the second cutout is spaced apart from the first cutout along the first portion, and the second cutout is shaped and dimensioned to receive and retain the other of the first terminal and the second terminal,
electrically connecting the clip to the first terminal by inserting the one of the first terminal and the second terminal into the first cutout to an extent that it is received within the first cutout,
electrically connecting the clip to the second terminal by inserting the other of the first cell terminal and the second cell terminal into the second cutout to an extent that it is received within the second cutout.

20. The method of claim 19, wherein
each of the first terminal and the second terminal protrude from a surface of a respective one of the first cell the second cell,
each of the first terminal and the second terminal include an outer surface that defines a recess, the recess having facing surfaces that are separated by a gap,
the clip has a thickness that is equal to or greater than a distance between the facing surfaces of the recess such that an interference fit exists between the clip and the facing surfaces of the recess, where the clip thickness corresponds to a distance between a cell-facing surface of the clip and an outward-facing surface of the clip, and the outward-facing surface of the clip is opposed to the cell-facing surface of the clip.
